(19) United States
(12) Patent Application Publication
(10) Pub. No.: US 2005/0267912 A1
(43) Pub. Date: Dec. 1, 2005

(54) Input data conversion apparatus for mobile information device, mobile information device, and control program of input data conversion apparatus

(75) Inventors: Syuichi Wada, Kawasaki (JP); Keiichi Iwamura, Kawasaki (JP); Junya Yamaguchi, Kawasaki (JP); Shunsuke Tanaka, Yokohama (JP); Kazuhiro Yoshihara, Kawasaki (JP)

Correspondence Address: STAAS & HALSEY LLP, SUITE 700, 1201 NEW YORK AVENUE, N.W., WASHINGTON, DC, 20005, US

(73) Assignees: FUJITSU LIMITED, Kawasaki (JP); NTT DoCoMo Inc., Tokyo (JP)

(21) Appl. No.: 11/203,176

(22) Filed: Aug. 15, 2005

Related U.S. Application Data
(63) Continuation of application No. PCT/JP03/06930, filed on Jun. 2, 2003.

(51) Int. Cl. G06F 7/00

(52) U.S. Cl. 707/104.1; 715/500

(57) ABSTRACT

A mobile phone is provided with a user dictionary to be used under privacy mode ON state and another user dictionary to be used under privacy mode OFF state. The two user dictionaries are automatically switched in conjunction with ON/OFF of the privacy mode. Further, the user dictionary used under privacy mode OFF state is prevented from being referred to under privacy mode ON state. This prevents information stored under privacy mode OFF state from being leaked.

### TECHNICAL FIELD

The present invention relates to an input data conversion apparatus which is implemented in a mobile information device and uses a user dictionary to convert predetermined input data to another predetermined data, a mobile information device provided with the same, and a control program of the input data conversion apparatus implemented in the mobile information device. Examples of the mobile information device include a mobile phone, a PHS (Personal Handy-phone System), a note-type personal computer (PC), a PDA (Personal Digital Assistant), a digital camera, and a digital video camera.

### BACKGROUND ART

As an input data conversion apparatus, a text processing apparatus adopting kana-kanji conversion system is known (refer to, for example, Jpn. Pat. Appln. Laid-Open Publication No. 59-111518). The text processing apparatus includes a general dictionary containing common nouns, verbs, and the like and a proper noun dictionary containing names of persons, places, and the like and selectively uses these dictionaries to constitute texts. In particular, the text processing apparatus is provided with an object to simplify switching operation of these dictionaries.

In recent years, mobile information devices such as a mobile phone and PDA, have been prevailed and, in particular, some mobile phone is provided with a function (privacy protection function) of preventing personal information such as address book or call history from being seen, with the case where a mobile phone of one user is lent to another taken into account.

When the operation mode is set to the privacy protection mode in such a mobile phone or the like, functions related to personal information such as an address book function or schedule note function are temporarily disabled, thereby preventing personal information from being leaked.

In a conventional mobile phone or the like, however, even in a state when the privacy protection mode has been set, an input data conversion function (kana-kanji conversion function or input prediction conversion function) that is likely to be used by a plurality of other functions itself is not disabled, with the result that the same user dictionary is used to perform the kanji-kana conversion irrespective of whether the operation mode is set to privacy protection mode or not. The information stored in the user dictionary needs to be protected as personal information under normal circumstances. However, in a conventional technique, the information stored in a privacy transparent mode (for example, in a state where the mobile phone is used by the owner thereof) can be utilized even from the privacy protection mode (for example, in a state where the stored data of the owner of the mobile phone needs to be protected from leakage in the case where the mobile phone is lent to a person other than the owner). In this case, there is a possibility that personal information is leaked.

For example, in some input data conversion function implemented in the recent mobile phone, an input sentence is acquired, and the entire sentence can be referred to as one of input candidates merely by inputting the first character of the sentence. In the mobile phone of such a type, it is quite likely that an input candidate such as “See you next Saturday at 9 o'clock” can be referred to by simply inputting “S”.

As another prior art, a technique in which information stored in the user dictionary are initialized is known. This technique can prevent the information that have been stored from being leaked. However, when the initialization is made, it is impossible to utilize the user dictionary in which the data stored so far has increased conversion efficiency thereof, deteriorating usability.

The present invention has been made to solve the above problems, and an object thereof is to provide an input data conversion apparatus for a mobile information device, a mobile information device, and a control program of the input data conversion apparatus implemented in the mobile information device capable of protecting privacy by selectively using the user dictionaries and having excellent usability.

### DISCLOSURE OF THE INVENTION

To solve the above problems, according to the present invention, there is provided an input data conversion apparatus for a mobile information device, the input data conversion apparatus being implemented in a mobile information device and using a user dictionary to convert predetermined input data into another predetermined data, comprising: a mode switching section that switches the operation mode between privacy mode under which privacy is protected and non-privacy mode under which the privacy mode is released; a first user dictionary available under the privacy mode set by the mode switching section; and a second user dictionary available under the non-privacy mode set by the mode switching section.

According to the present invention, there is provided a input data conversion apparatus for a mobile information device, the input data conversion apparatus being implemented in a mobile information device and using a user dictionary to convert predetermined input data into another predetermined data, comprising: a mode switching section that switches the operation mode between privacy mode under which privacy is protected and non-privacy mode under which the privacy mode is released; a dictionary registration section that separately registers, in the user dictionary, first data that can be converted by the user dictionary under the privacy mode and second data that can be converted by the user dictionary under the non-privacy mode; and a dictionary data selection section that selects the first data or second data that have been registered in the user dictionary depending on the operation mode set by the mode switching section.

The dictionary registration section sets the data to be registered in the user dictionary under the privacy mode as the first data and sets the data to be registered in the user dictionary under the non-privacy mode as third data and registers the first and third data in the user dictionary, and the dictionary data selection section handles the first and third data as the second data under the non-privacy mode.

The dictionary registration section sets the data to be registered in the user dictionary under the privacy mode as the first data and sets the data to be registered in the user dictionary under the non-privacy mode as the second data and registers the first and second data in the user dictionary.

In the input data conversion apparatus for a mobile information device, the input data conversion apparatus is a kana-kanji conversion apparatus.

According to the present invention, there is provided a mobile information device having a function of using a user dictionary to convert predetermined input data into another predetermined data, comprising: a mode switching section that switches the operation mode between privacy mode under which privacy is protected and non-privacy mode under which the privacy mode is released; a first user dictionary available under the privacy mode set by the mode switching section; and a second user dictionary available under the non-privacy mode set by the mode switching section.

According to the present invention, there is provided a mobile information device having a function of using a user dictionary to convert predetermined input data into another predetermined data, comprising: a mode switching section that switches the operation mode between privacy mode under which privacy is protected and non-privacy mode under which the privacy mode is released; a dictionary registration section that separately registers, in the user dictionary, first data that can be converted by the user dictionary under the privacy mode and second data that can be converted by the user dictionary under the non-privacy mode; and a dictionary data selection section that selects the first data or second data that have been registered in the user dictionary depending on the operation mode set by the mode switching section.

According to the present invention, there is provided a control program of an input data conversion apparatus for a mobile information device, the input data conversion apparatus being implemented in a mobile information device and using a user dictionary to convert predetermined input data into another predetermined data, the control program allowing a computer to execute: a mode determination step that determines, based on a data conversion instruction, whether privacy mode under which privacy is protected or non-privacy mode under which the privacy mode is released has been set; and a data conversion step that uses a first user dictionary available under the privacy mode to perform data conversion when the mode determination step determines that the privacy mode has been set, and uses a second user dictionary available under the non-privacy mode to perform data conversion when the mode determination step determines that the non-privacy mode has been set.

According to the present invention, there is provided a control program of an input data conversion apparatus for a mobile information device, the input data conversion apparatus being implemented in a mobile information device and using a user dictionary to convert predetermined input data into another predetermined data, the control program allowing a computer to execute: a mode determination step that determines, based on a data conversion instruction, whether privacy mode under which privacy is protected or non-privacy mode under which the privacy mode is released has been set; and a data conversion step that selects first data that has been registered in the user dictionary so as to be available under the privacy mode to perform data conversion when the mode determination step determines that the privacy mode has been set, and selects second data that has been registered in the user dictionary so as to be available under the non-privacy mode to perform data conversion when the mode determination step determines that the non-privacy mode has been set.

It is possible for the above control program to allow a computer to further execute: a mode determination step that determines, based on a dictionary registration instruction, whether privacy mode under which privacy is protected or non-privacy mode under which the privacy mode is released has been set; and a dictionary registration step that registers registration data as the first data when the mode determination step determines that the privacy mode has been set, and registers registration data as third data when the mode determination step determines that the non-privacy mode has been set, the first data and third data constituting the second data.

According to the present invention, there is provided a control program of an input data conversion apparatus for a mobile information device, the input data conversion apparatus being implemented in a mobile information device and using a user dictionary to convert predetermined input data into another predetermined data, the control program allowing a computer to execute: a mode setting step that sets, based on a mode setting instruction, either privacy mode under which privacy is protected or non-privacy mode under which the privacy mode is released; and a data conversion step that uses a first user dictionary available under the privacy mode to perform data conversion based on a data conversion instruction when the privacy mode has been set, and uses a second user dictionary available under the non-privacy mode to perform data conversion based on a data conversion instruction when the non-privacy mode has been set.

According to the above configurations, it is possible to handle the information stored in the user dictionary as personal information to be kept secret simply by setting the privacy mode, thereby preventing the personal information from being leaked. Further, it is unnecessary to delete the personal information to be kept secret, thus resulting in excellent usability.

### BRIEF DESCRIPTION OF THE DRAWINGS

FIG. 1 is a block diagram showing a configuration of a mobile phone in a first embodiment of the present invention;

FIG. 2 is a view schematically showing an internal configuration of “kana-kanji conversion apparatus” serving as an input data conversion apparatus and a configuration of a user dictionary for use in the apparatus;

FIG. 3 is a flowchart of a user dictionary switching process;

FIG. 4 is privacy mode setting windows used at the time of switching to the privacy mode;

FIGS. 5A and 5B are image views showing data in a dictionary in the case where the present invention is used in the Japanese language version; FIG. 5A is an image view showing data in a dictionary 11B used under privacy mode OFF state, and FIG. 5B is an image view showing data in a dictionary 11A used under privacy mode ON state;

FIGS. 6A and 6B are image views showing data in a dictionary in the case where the present invention is used in the English language version; FIG. 6A is an image view showing data in a dictionary 11B used under privacy mode OFF state, and FIG. 6B is an image view showing data in a dictionary 11A used under privacy mode ON state;

FIG. 7 is a block diagram showing a configuration of a kana-kanji conversion apparatus serving as an input data conversion apparatus;

FIG. 8 is a flowchart showing a process of storing candidates in the user dictionary performed in a candidate filtering section shown in FIG. 7;

FIG. 9 is a flowchart of a process of acquiring the candidates from the user dictionary performed in a candidate filtering section; and

FIGS. 10A and 10B are image views showing data stored (registered) in the user dictionary.

### BEST MODE FOR CARRYING OUT THE INVENTION

Embodiments of the present invention will be described below with reference to the accompanying drawings.

In the present specification, a state where a function of protecting privacy is allowed to operate to prevent one's own dictionary data from being used by others (referred to as “privacy mode” in the present specification, in which a dictionary data of the owner of a mobile phone is prevented from being used in the case where the mobile phone is used by a person other than the owner) is noted as “privacy mode ON”; whereas a normal use state where one's own dictionary data is used by him or herself (referred to as non-privacy mode in the present specification, in which a dictionary data of the owner of a mobile phone is allowed to be used in the case where the mobile phone is used by the owner of the mobile phone) is noted as “privacy mode OFF”. “User dictionary” in the following description indicates a dictionary for use in the input data conversion apparatus according to the present invention and, unless otherwise specified, includes all of the dictionaries for study or registration purpose used in so-called a kana-kanji conversion apparatus, such as a user dictionary for use in a general kana-kanji conversion system, an input prediction conversion dictionary that predicts subsequent inputs at the time point when the first several characters have been input to perform conversion.

### First Embodiment

In the first embodiment, a mobile phone has a user dictionary used under privacy mode ON and another user dictionary used under privacy mode OFF, in which the two dictionaries are automatically switched in conjunction with ON/OFF of the privacy mode. The user dictionary used under privacy mode OFF state is prevented from being referred to under privacy mode ON state, preventing information stored under privacy mode OFF from being leaked. Incidentally, in the first embodiment, the user dictionary used under privacy mode ON state can be referred to under privacy mode OFF state.

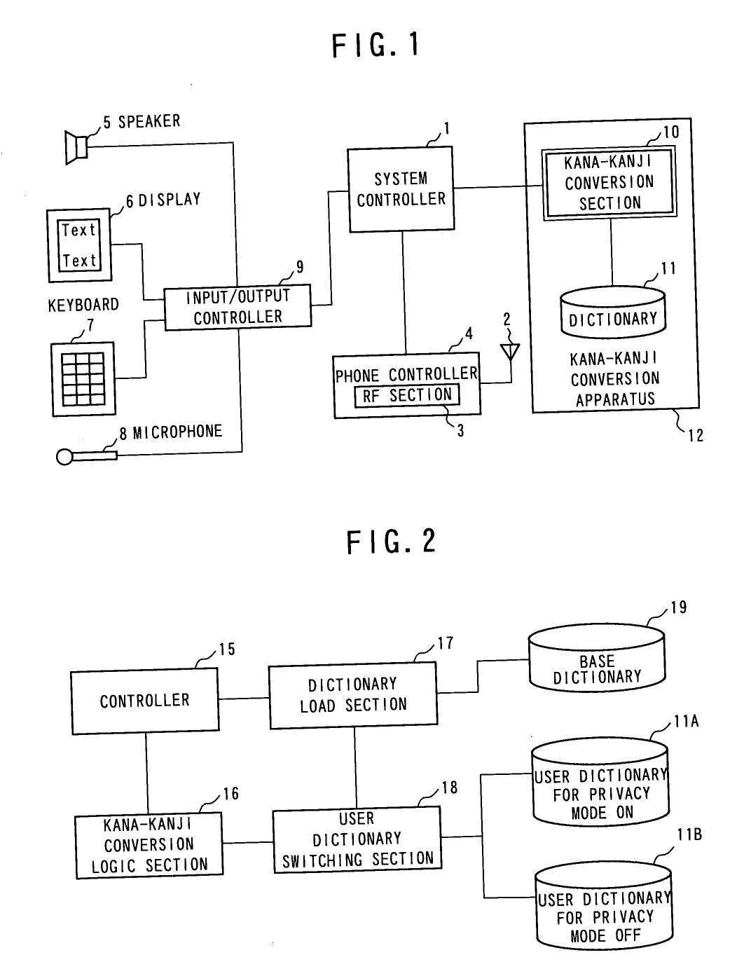

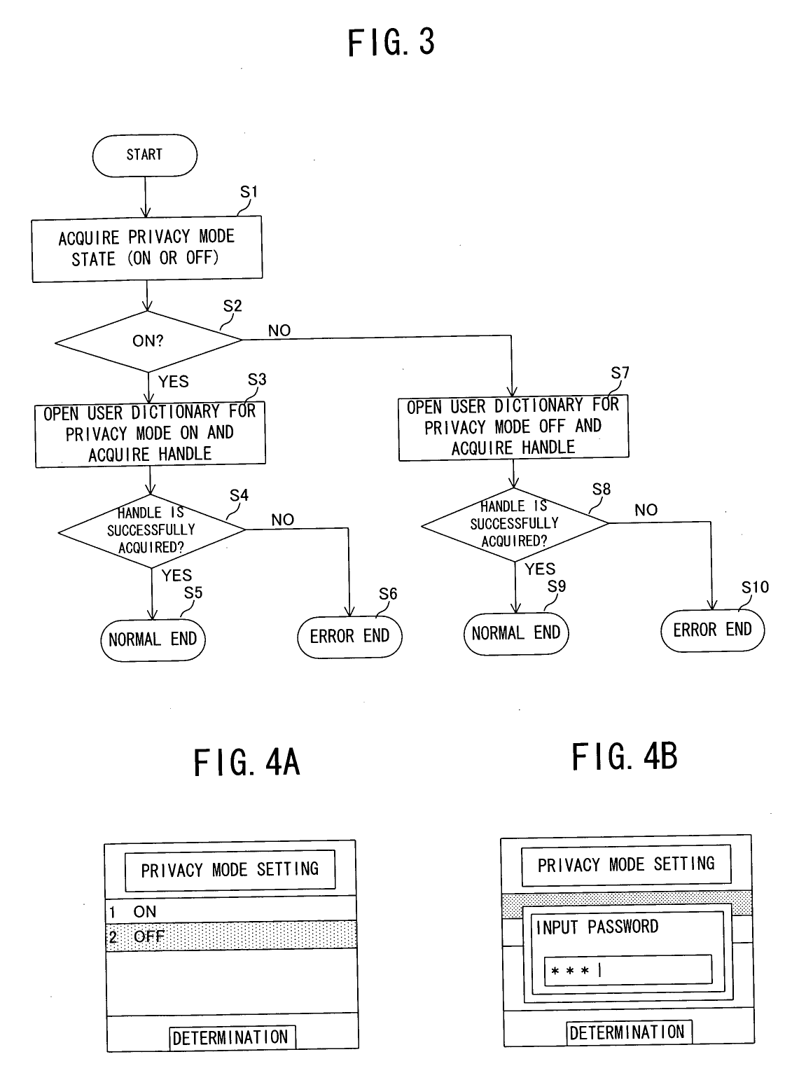

FIG. 1 is a block diagram showing a configuration of a mobile phone in a first embodiment of the present invention, FIG. 2 is a view schematically showing an internal configuration of “kana-kanji conversion apparatus” serving as an input data conversion apparatus and a configuration of a user dictionary for use in the apparatus, and FIG. 3 is a flowchart of a user dictionary switching process.

The mobile phone according to the first embodiment includes a system controller 1 which controls the entire system of the mobile phone, a phone controller 4 which is connected to an antenna 2 and provided with an RF section 3 to thereby perform phone control, a speaker 5, a display 6, a keyboard 7, a microphone 8, an input/output controller 9 which performs input/output control for the speaker 5, display 6, keyboard 7, and microphone 8, a kana-kanji conversion section (data conversion section) 10, and a dictionary 11. An input data conversion apparatus according to the present invention is constituted by a kana-kanji conversion apparatus 12 including the kana-kanji conversion section 10 and dictionary 11.

In the configuration as shown in FIG. 1, when a user performs input operation on the keyboard 7, key codes are transmitted through the input/output controller 9 to the system controller 1. The system controller 1 receives the key codes, transmits them to the kana-kanji conversion section 10, and obtains a conversion result from the kana-kanji conversion section 10.

The kana-kanji conversion apparatus shown in FIG. 2 includes a controller 15 which controls the entire kana-kanji conversion apparatus, a kana-kanji conversion logic section 16, a dictionary load section 17, a user dictionary switching section 18, base dictionary 19, a user dictionary 11A for privacy mode ON (first user dictionary), and a user dictionary 11B for privacy mode OFF (second user dictionary).

The controller 15 receives the key codes from the system controller 1 and transmits them to the kana-kanji conversion logic section 16, where a conversion process is performed. The kana-kanji conversion logic section 16 accesses the dictionary load section 17 through the controller 15 to acquire the dictionary to be used for the conversion process. The dictionary load section 17 opens/loads the base dictionary 19 as well as selectively opens/loads the dictionary 11A or 11B through the user dictionary switching section 18.

The user dictionary switching section 18 opens the user dictionary according to a flowchart of FIG. 3. In the user dictionary opening process, the user dictionary switching section 18 acquires a privacy mode state (ON or OFF) (step S1) before opening of the user dictionary. When the acquired state is privacy mode ON (Yes in step S2), the user dictionary switching section 18 opens the user dictionary for privacy mode ON (first dictionary) and tries to acquire the handle of predetermined data (step S3). When the user dictionary switching section 18 successfully acquires the handle (YES in step S4), the process is normally ended (step S5); whereas when the user dictionary switching section 18 cannot successfully acquire the handle, the process is ended with an error (step S6). The above process is performed based on an kana-kanji conversion instruction issued through the user's key operation.

When the acquired state is privacy mode OFF (No in step S2), the user dictionary switching section 18 opens the user dictionary for privacy mode OFF (second dictionary) and tries to acquire the handle of predetermined data (step S7). When the user dictionary switching section 18 successfully acquires the handle (YES in step S8), the process is normally ended (step S9); whereas when the user dictionary switching section 18 cannot successfully acquire the handle, the process is ended with an error (step S10).

The ON/OFF switching of privacy mode will next be described. FIG. 4 is a privacy mode setting window used at the time of switching to the privacy mode. The ON/OFF switching of privacy mode in the embodiment is started by activation of “privacy mode setting” available in the setting items or menu of the mobile phone. Alternatively, it is possible to assign “privacy mode setting” to a certain key on the mobile phone. In this case, a depress of the key can activate “privacy mode setting”. In the present embodiment, the privacy mode setting window shown in FIG.4 serves as a mode switching means. When the user selects ON or OFF on the privacy mode setting window as shown in FIG. 4A (ON is selected in FIG. 4A) and depresses a “determination” button, the window as shown in FIG. 4B is displayed. Then when the user inputs a predetermined password to the window, the setting of privacy mode is completed.

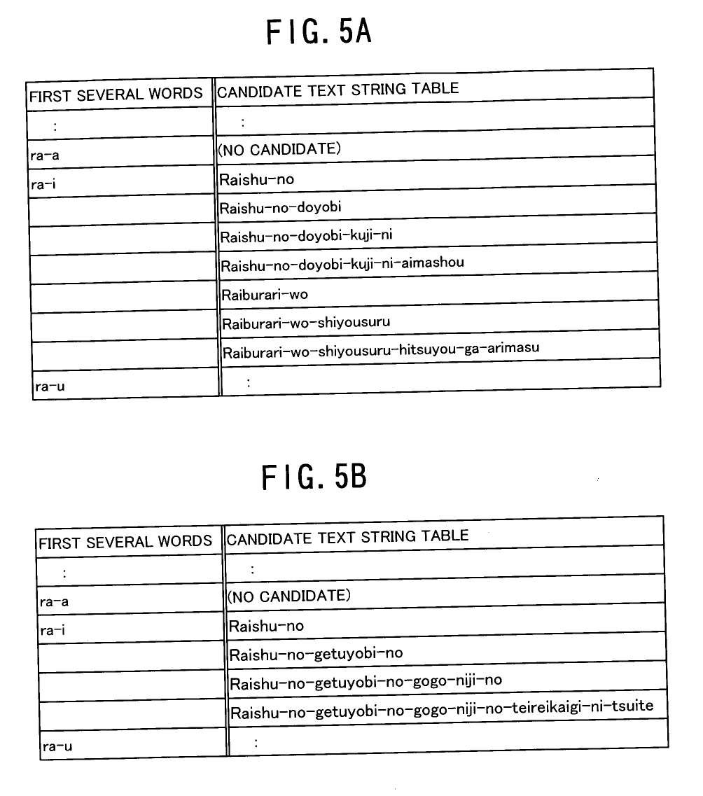

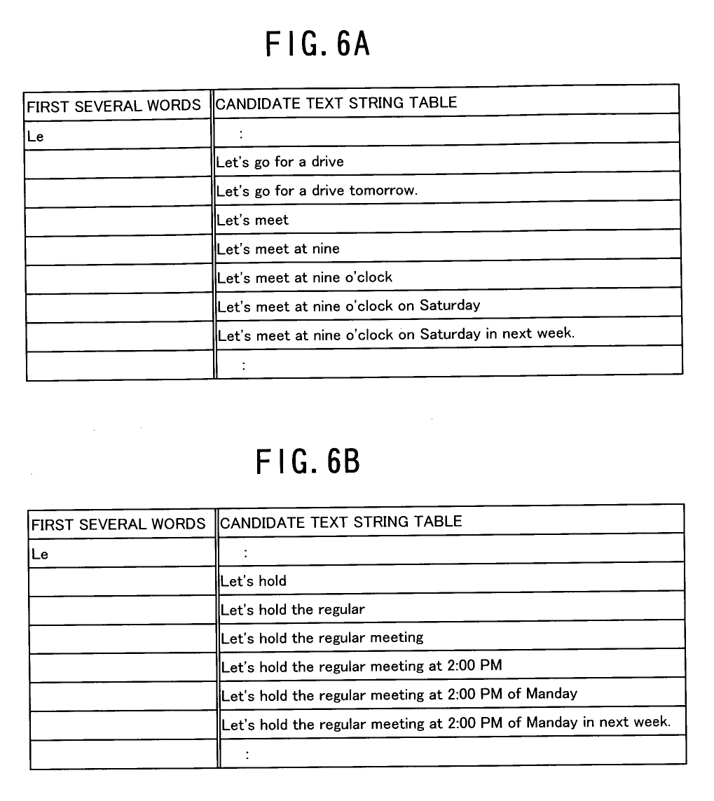

The content of the user dictionary is exemplified in FIGS. 5 and 6.

In the first embodiment, the user dictionary is constituted by the user dictionaries 11A and 11B, which are selectively used depending on ON/OFF of the privacy mode. The results acquired under privacy mode OFF state are stored in the dictionary 11B for privacy mode OFF (second dictionary), and the results acquired under privacy mode ON state are stored in the dictionary 11A for privacy mode ON.

FIG. 5A is an image view showing data in the dictionary 11B used in a privacy mode OFF state. In this dictionary, two Japanese candidate sentences (“Raishu-no-doyobi-kuji-ni-aimashou”, which means “See you next Saturday at 9 o'clock”, and “Raiburari-wo-shiyousuru-hitsuyou-ga-arimasu”, which means “You need to use library”) have been registered in association with “Rai” (the first two characters of the registered sentences).

FIG. 5B is an image view showing data in the dictionary 11A for privacy mode ON. In this dictionary, one Japanese sentence (“Raishu-no-getuyobi-no-gogo-niji-no-teireikaigi-ni-tsuite” which means “About regular meeting held next Monday at 2 PM”) has been registered in association with “Rai”. These two dictionaries are selectively used to acquire candidate sentences (or candidate words) depending on the privacy mode.

FIGS. 6A and 6B are image views showing data in a dictionary in the case where the present invention is used in the English language version. FIG. 6A is an image view showing data in a dictionary used in privacy mode OFF state. In this dictionary, two English candidate sentences: “Let's go a drive tomorrow” and “Let's meet at 9 o'clock on Saturday in next week” have been registered in association with an input alphabet string “Le”.

FIG. 6B is an image view showing data in the dictionary used in privacy mode OFF state. In this dictionary, one English candidate sentence: “Let's hold the regular meeting at 2:00 PM of Monday in next week” has been registered in association with an input alphabet string “Le”.

### Second Embodiment

A second embodiment of the present invention will be described below. In the second embodiment, only one user dictionary is used, in which the data to be registered in the dictionary are separated from one another depending on ON/OFF of the privacy mode. In privacy mode ON state, only the dictionary data that have been registered in privacy mode ON state can be used, thereby protecting privacy. In this case, a flag indicating ON or OFF of the privacy mode at the time of registration/storage is added to word information registered/stored in the user dictionary. In the case where the dictionary is used under privacy mode ON state, words that have been registered under privacy mode OFF state are not allowed to be output as data candidates, thereby preventing information that have been input under privacy mode OFF state from being leaked. In the second embodiment, in the case where the dictionary is used under privacy mode OFF state, words and sentences that have been registered under privacy mode ON state are output as data candidates.

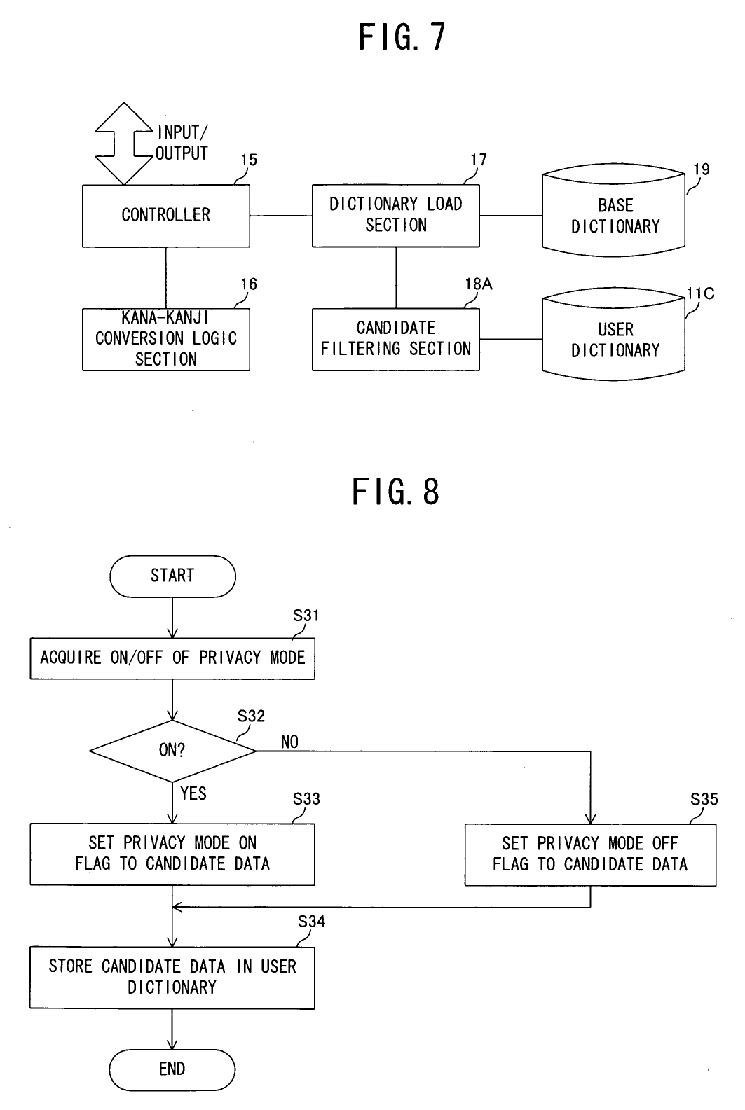

FIG. 7 is a block diagram showing a configuration of a kana-kanji conversion apparatus serving as an input data conversion apparatus. In FIG. 7, the same reference numerals denote the same or corresponding parts as shown in FIG. 2, and the descriptions thereof will be omitted. In FIG. 7, only one user dictionary 11C to be shared irrespective of ON/OFF of the privacy mode is shown.

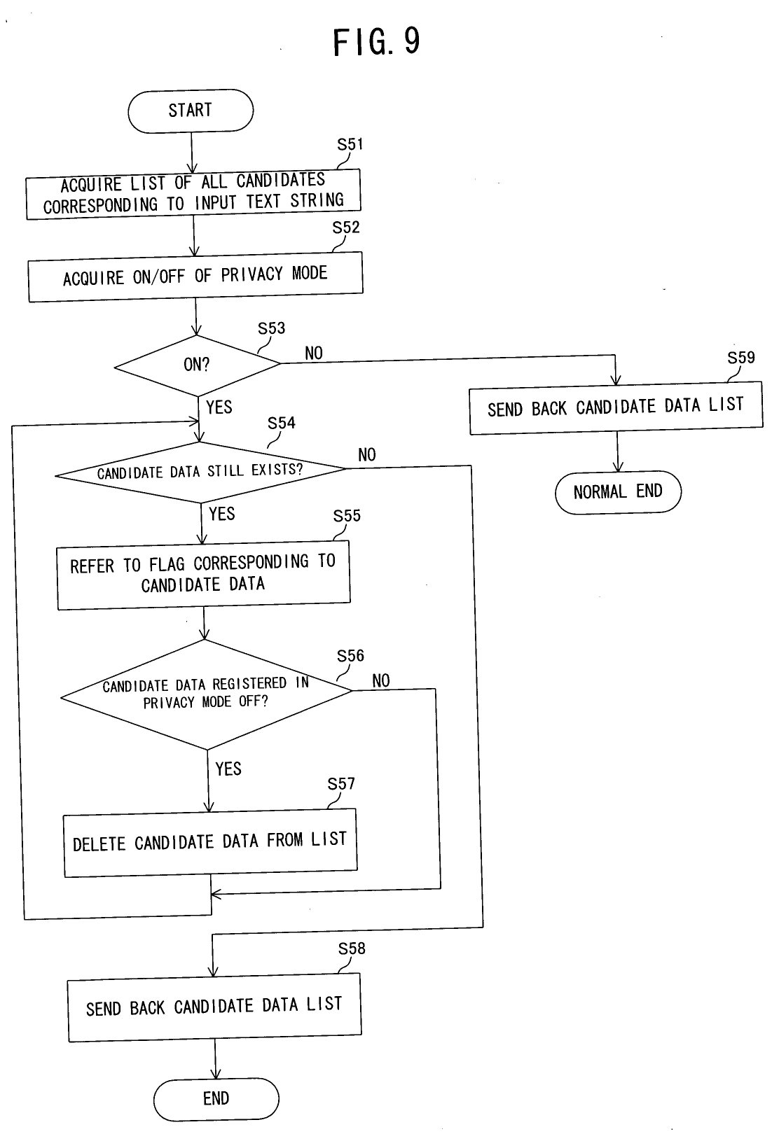

FIG. 8 is a flowchart showing a process of storing candidates in the user dictionary 11C performed in a candidate filtering section 18A shown in FIG. 7. FIG. 9 is a flowchart of a process of acquiring the candidates from the user dictionary 11C performed in a candidate filtering section 18A. Hereinafter, an operation of the second embodiment will be described with reference to FIGS. 8 and 9.

When a user performs input operation on the keyboard 7 shown in FIG. 1, key codes are transmitted through the input/output controller 9 to the system controller 1. The system controller 1 receives the key codes, transmits them to the kana-kanji conversion section 10, and obtains a conversion result from the kana-kanji conversion section 10.

In the kana-kanji conversion apparatus of FIG. 7, the controller 15 receives the key codes from the system controller 1 and transmits them to the kana-kanji conversion logic section 16, where a conversion process is performed. The kana-kanji conversion logic section 16 accesses the dictionary load section 17 through the controller 15 to acquire the dictionary to be used for the conversion process. An access of the dictionary load section 17 to the user dictionary 11C is made through a candidate filtering section 18A.

When candidate data is stored in the user dictionary 11C, a flag indicating ON/OFF of the current privacy mode is stored together with the candidate data by the candidate filtering section 18A (which will be described later in FIG. 8).

At the time of outputting the candidate data from the user dictionary, the candidate filtering section 18A determines the candidate data to be output depending on ON/OFF of the current privacy mode (which will be described later in FIG. 9).

An operation of storing the candidate data will be described with reference to FIG. 8. When an instruction to store (register) the candidate data is issued through the user's key operation, the candidate filtering section 18A firstly acquires whether privacy mode is set ON or OFF (step S31) and determines the current privacy mode (step S32). When determining that privacy mode is ON (YES in step S32), the candidate filtering section 18A sets a privacy mode ON flag to corresponding candidate data (step S33), stores the candidate data in the user dictionary (step S34), and ends this process.

When determining that the privacy mode is OFF (No in step S32), the candidate filtering section 18A sets a privacy mode OFF flag to corresponding candidate data (step S35), stores the candidate data in the user dictionary (step S34), and ends this process.

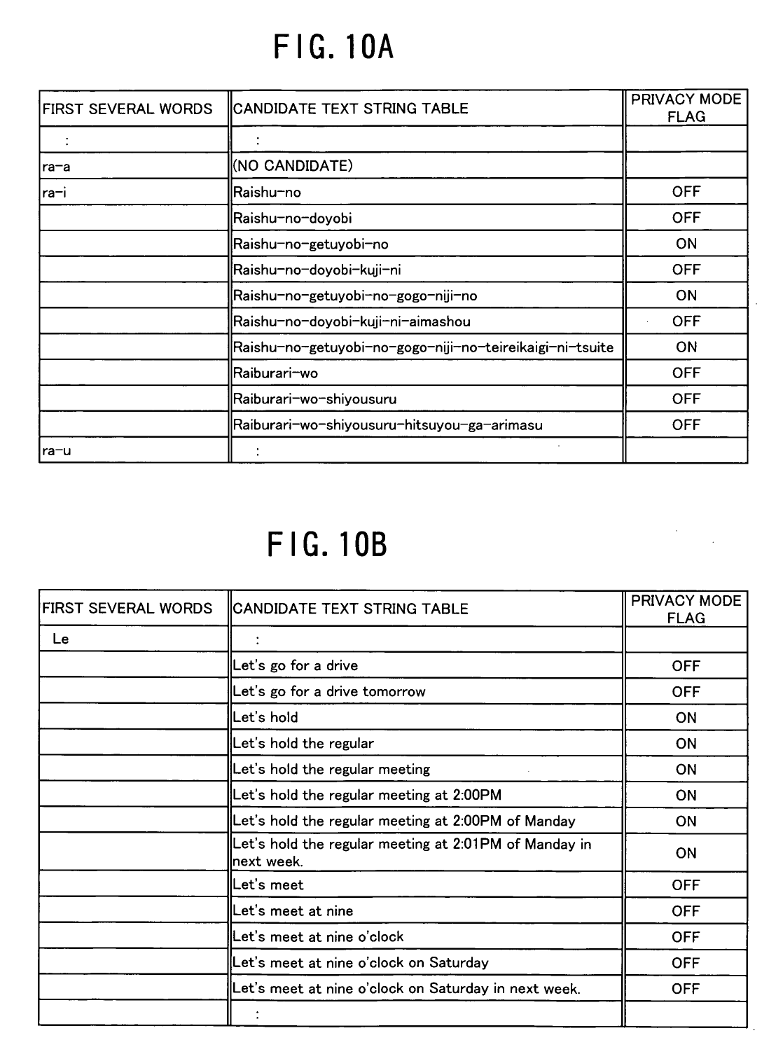

FIG. 10 is an image view showing data that have been stored (registered) in the user dictionary as described above. The same dictionary is shared between privacy modes ON and OFF in the second embodiment, and therefore, flags indicating the state of privacy mode in which respective candidate text strings (data) have been acquired are set to the corresponding text strings stored in the user dictionary. FIG. 10A shows the content of the user dictionary obtained by modifying the content of the user dictionary in the first embodiment (shown in FIGS. 5A and 5B) according to the second embodiment. FIG. 10B shows the content of the user dictionary obtained by modifying the content of the user dictionary in the first embodiment (shown in FIGS. 6A and 6B) according to the second embodiment.

An operation of reading out the candidate data will be described with reference to FIG. 9. Firstly, based on an data conversion instruction issued through the user's key operation, the candidate filtering section 18A firstly acquires a list of all candidates corresponding to the input text string (step S51). The candidate filtering section 18A then acquires information indicating ON/OFF of the privacy mode (step S52) and determines the current privacy mode (ON or OFF)(step S53). When determining that privacy mode is ON (Yes in step S53), the candidate filtering section 18A determines whether candidate data that has not been referred to exists in the list (step S54). When determining that the candidate data still exists (Yes in step S54), the candidate filtering section 18A refers to the flag corresponding to the still-existing candidate data (step S55). When determining that the relevant data has been registered in privacy mode OFF (Yes in step S56), the candidate filtering section 18A deletes the relevant candidate data from the list (step S57) and returns to step S54. When determining that there is no candidate data to be referred to (No in step S54), the acquired list of the candidate data is sent back to the dictionary load section 17 (step S58).

On the other hand, when determining that privacy mode is not ON, that is, privacy mode is OFF (No in step S53), the candidate filtering section 18A sends back the list including all candidate data to the dictionary load section 17.

As described above, different flags are set to the data to be registered in the dictionary depending on ON/OFF of the privacy mode in the second embodiment, in which only the dictionary data that have been registered under privacy mode ON state are allowed to be used under privacy mode ON state, and all data registered in the user dictionary are allowed to be used irrespective of ON/OFF of the privacy mode under privacy mode OFF state, thereby realizing protection of privacy. The configuration of the second embodiment eliminates the need of providing two user dictionaries of different types as in the case of the second embodiment, making it easy to make effective use of a memory.

It is possible to modify the second embodiment into another configuration in which only the dictionary data (whose privacy mode flags are OFF) that have been registered under privacy mode OFF state are used for the dictionary conversion under privacy mode OFF state. With this configuration, when an owner of a mobile phone uses the phone under privacy mode OFF state, he or she can preferentially use frequently-used dictionary data in order to perform data conversion.

Although the determination of ON/OFF of the privacy mode is made every time a conversion or registration instruction is issued in the above embodiments, it becomes unnecessary to make the determination for each instruction by adopting a configuration in which after ON or OFF mode has been set, the above instructions are received in the set mode.

Although the mobile phone has been taken as an example of a mobile information device in the above embodiments, it goes without saying that the present invention can be applied to a PHS, a note-type personal computer, a PDA, a digital camera, a digital video camera, and the like, in addition to the mobile phone.

### INDUSTRIAL APPLICABILITY

As described above in detail, according to the present invention, it is possible to handle the information stored in the user dictionary as personal information to be kept secret simply by setting the privacy mode, thereby preventing the personal information from being leaked. Further, it is unnecessary to delete the personal information to be kept secret, thus resulting in excellent usability.

1. An input data conversion apparatus for a mobile information device, the input data conversion apparatus being implemented in a mobile information device and using a user dictionary to convert predetermined input data into another predetermined data, comprising:
a mode switching section that switches the operation mode between privacy mode under which privacy is protected and non-privacy mode under which the privacy mode is released;
a first user dictionary available under the privacy mode set by the mode switching section; and
a second user dictionary available under the non-privacy mode set by the mode switching section.

2. An input data conversion apparatus for a mobile information device, the input data conversion apparatus being implemented in a mobile information device and using a user dictionary to convert predetermined input data into another predetermined data, comprising:
a mode switching section that switches the operation mode between privacy mode under which privacy is protected and non-privacy mode under which the privacy mode is released;
a dictionary registration section that separately registers, in the user dictionary, first data that can be converted by the user dictionary under the privacy mode and second data that can be converted by the user dictionary under the non-privacy mode; and
a dictionary data selection section that selects the first data or second data that have been registered in the user dictionary depending on the operation mode set by the mode switching section.

3. The input data conversion apparatus for a mobile information device according to claim 2, wherein
the dictionary registration section sets the data to be registered in the user dictionary under the privacy mode as the first data and sets the data to be registered in the user dictionary under the non-privacy mode as third data and registers the first and third data in the user dictionary, and
the dictionary data selection section handles the first and third data as the second data under the non-privacy mode.

4. The input data conversion apparatus for a mobile information device according to claim 2, wherein
the dictionary registration section sets the data to be registered in the user dictionary under the privacy mode as the first data and sets the data to be registered in the user dictionary under the non-privacy mode as the second data and registers the first and second data in the user dictionary.

5. The input data conversion apparatus for a mobile information device according to claim 1, wherein
the input data conversion apparatus is a kana-kanji conversion apparatus.

6. A mobile information device having a function of using a user dictionary to convert predetermined data into another predetermined data, comprising:
a mode switching section that switches the operation mode between privacy mode under which privacy is protected and non-privacy mode under which the privacy mode is released;
a first user dictionary available under the privacy mode set by the mode switching section; and
a second user dictionary available under the non-privacy mode set by the mode switching section.

7. A mobile information device having a function of using a user dictionary to convert predetermined input data into another predetermined data, comprising:
a mode switching section that switches the operation mode between privacy mode under which privacy is protected and non-privacy mode under which the privacy mode is released;
a dictionary registration section that separately registers, in the user dictionary, first data that can be converted by the user dictionary under the privacy mode and second data that can be converted by the user dictionary under the non-privacy mode; and
a dictionary data selection section that selects the first data or second data that have been registered in the user dictionary depending on the operation mode set by the mode switching section.

8. A control program of an input data conversion apparatus for a mobile information device, the input data conversion apparatus being implemented in a mobile information device and using a user dictionary to convert predetermined input data into another predetermined data,
the control program allowing a computer to execute:
a mode determination step that determines, based on a data conversion instruction, whether privacy mode under which privacy is protected or non-privacy mode under which the privacy mode is released has been set; and
a data conversion step that uses a first user dictionary available under the privacy mode to perform data conversion when the mode determination step determines that the privacy mode has been set, and uses a second user dictionary available under the non-privacy mode to perform data conversion when the mode determination step determines that the non-privacy mode has been set.

9. A control program of an input data conversion apparatus for a mobile information device, the input data conversion apparatus being implemented in a mobile information device and using a user dictionary to convert predetermined input data into another predetermined data,
the control program allowing a computer to execute:
a mode determination step that determines, based on a data conversion instruction, whether privacy mode under which privacy is protected or non-privacy mode under which the privacy mode is released has been set; and
a data conversion step that selects first data that has been registered in the user dictionary so as to be available under the privacy mode to perform data conversion when the mode determination step determines that the privacy mode has been set, and selects second data that has been registered in the user dictionary so as to be available under the non-privacy mode to perform data conversion when the mode determination step determines that the non-privacy mode has been set.

10. The control program of an input data conversion apparatus for a mobile information device according to claim 9, the control program allowing a computer to execute:
a mode determination step that determines, based on a dictionary registration instruction, whether privacy mode under which privacy is protected or non-privacy mode under which the privacy mode is released has been set; and
a dictionary registration step that registers registration data as the first data when the mode determination step determines that the privacy mode has been set, and registers registration data as third data when the mode determination step determines that the non-privacy mode has been set, the first data and third data constituting the second data.

11. A control program of an input data conversion apparatus for a mobile information device, the input data conversion apparatus being implemented in a mobile information device and using a user dictionary to convert predetermined input data into another predetermined data,
the control program allowing a computer to execute:
a mode setting step that sets, based on a mode setting instruction, either privacy mode under which privacy is protected or non-privacy mode under which the privacy mode is released; and
a data conversion step that uses a first user dictionary available under the privacy mode to perform data conversion based on a data conversion instruction when the privacy mode has been set, and uses a second user dictionary available under the non-privacy mode to perform data conversion based on a data conversion instruction when the non-privacy mode has been set.
